(19) United States
(12) Patent Application Publication
(10) Pub. No.: US 2024/0393872 A1
(43) Pub. Date: Nov. 28, 2024

(54) AVATAR GENERATION

(71) Applicant: Apple Inc., Cupertino, CA (US)

(72) Inventor: Ivan S. MARIC, San Francisco, CA (US)

(21) Appl. No.: 18/694,375

(22) PCT Filed: Sep. 16, 2022
(86) PCT No.: PCT/US2022/043880

§ 371 Date: Mar. 21, 2024

Related U.S. Application Data
(60) Provisional application No. 63/248,129, filed on Sep. 24, 2021.

(51) Int. Cl. G06F 3/01; G06T 11/00; G06V 40/16

(52) U.S. Cl. CPC G06F 3/012; G06F 3/013; G06T 11/00; G06V 40/161; G06V 40/168; G06T 2210/36

(57) ABSTRACT

Wearable electronic devices can provide user-facing sensors to track facial features of a person wearing the wearable electronic device. Detections can be transmitted to other wearable electronic devices so that avatars of the person can be displayed thereon. The users observing such avatars can respond to the selected level of realism, and the wearable electronic devices worn by such users can detect or otherwise receive feedback from the users, for example with sensors to track facial features. Such reactions can be used to determine whether the avatar should be adjusted, for example to be more cartoonlike or lifelike. Additionally, reactions over time can be tracked to determine a user's overall responsiveness to cartoonlike or lifelike avatars, and futures avatars can be generated based on such determinations.

### CROSS-REFERENCE TO RELATED APPLICATION

This application claims the benefit of U.S. Provisional Application No. 63/248,129, entitled “AVATAR GENERATION FOR HEAD-MOUNTABLE DEVICES,” filed Sep. 24, 2021, the entirety of which is incorporated herein by reference.

### TECHNICAL FIELD

The present description relates generally to head-mountable devices, and, more particularly, to avatar generation for head-mountable devices.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a top view of a head-mountable device, according to some embodiments of the present disclosure.

FIG. 2 illustrates a rear view of a head-mountable device, according to some embodiments of the present disclosure.

FIG. 3 illustrates a top view of head-mountable devices in use by users, according to some embodiments of the present disclosure.

FIG. 4 illustrates a head-mountable device displaying an example user interface, according to some embodiments of the present disclosure.

FIG. 5 illustrates a head-mountable device displaying an example user interface, according to some embodiments of the present disclosure.

FIG. 6 illustrates a flow chart for a process having operations performed by a head-mountable device, according to some embodiments of the present disclosure.

FIG. 7 illustrates a flow chart for a process having operations performed by a head-mountable device, according to some embodiments of the present disclosure.

FIG. 8 illustrates a block diagram of a head-mountable device, in accordance with some embodiments of the present disclosure.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device.

Multiple users wearing head-mountable devices can interact with each other in a computer-generated reality, in which each user can see at least one other as represented with an avatar. Such avatars can include features that resemble the users they are intended to represent, while also providing the features in a way that is other than an exact representation of the users. For example, the avatars can have a more cartoonlike appearance that enhances or simplifies certain features of the users.

In avatar construction, a phenomenon known as “the uncanny valley” refers to a region in the level of realism with which an avatar is rendered. The uncanny valley is the region between cartoon and lifelike where some users report discomfort with the avatar's realism. That is, users often prefer avatars that are highly cartoonlike or highly lifelike. There exists a region in between that some users find unappealing. It can be beneficial to generate avatars that are appealing by the users observing them.

Head-mountable devices of the present disclosure can provide user-facing sensors to track facial features of a person wearing the head-mountable device. Detections can be transmitted to other head-mountable devices so that avatars of the person can be displayed thereon. The users observing such avatars can respond to the selected level of realism, and the head-mountable devices worn by such users can detect or otherwise receive feedback from the users, for example with sensors to track facial features. Such reactions can be used to determine whether the avatar should be adjusted, for example to be more cartoonlike or lifelike. Additionally, reactions over time can be tracked to determine a user's overall responsiveness to cartoonlike or lifelike avatars, and futures avatars can be generated based on such determinations.

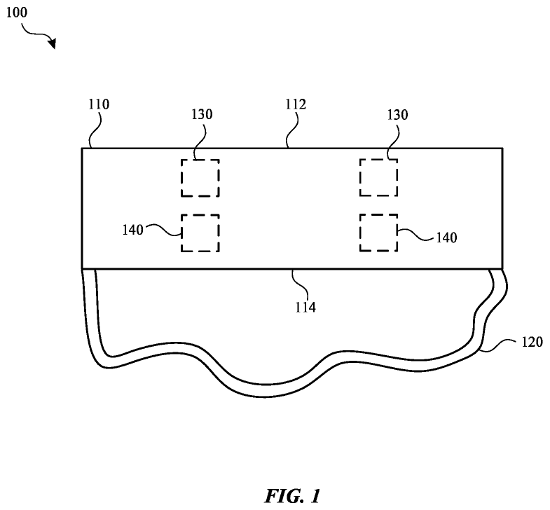

These and other embodiments are discussed below with reference to FIGS. 1-8. However, those skilled in the art will readily appreciate that the detailed description given herein with respect to these Figures is for explanatory purposes only and should not be construed as limiting.

According to some embodiments, for example as shown in FIG. 1, a head-mountable device 100 includes a frame 110 and a 200. The frame 110 can be worn on a head of a user. The frame 110 can be positioned in front of the eyes of a user to provide information within a field of view of the user. The frame 110 can provide nose pads and/or other portions to rest on a user's nose, forehead, cheeks, and/or other facial features as described further herein.

The frame 110 can be supported on a user's head with the head engager 120. The head engager 120 can wrap around or extend along opposing sides of a user's head. The head engager 120 can optionally include earpieces for wrapping around or otherwise engaging or resting on a user's ears. It will be appreciated that other configurations can be applied for securing the head-mountable device 100 to a user's head. For example, one or more bands, straps, belts, caps, hats, or other components can be used in addition to or in place of the illustrated components of the head-mountable device 100. By further example, the head engager 120 can include multiple components to engage a user's head.

The frame 110 can provide structure around a peripheral region thereof to support any internal components of the frame 110 in their assembled position. For example, the frame 110 can enclose and support various internal components (including for example integrated circuit chips, processors, memory devices and other circuitry) to provide computing and functional operations for the head-mountable device 100, as discussed further herein. While several components are shown within the frame 110, it will be understood that some or all of these components can be located anywhere within or on the head-mountable device 100. For example, one or more of these components can be positioned within the head engager 120 and/or the frame 110 of the head-mountable device 100.

The frame 110 can include and/or support one or more cameras 130. The cameras 130 can be positioned on or near an outer side 112 of the frame 110 to capture images of views external to the head-mountable device 100. As used herein, an outer side of a portion of a head-mountable device is a side that faces away from the user and/or towards an external environment. The captured images can be used for display to the user or stored for any other purpose. Each of the cameras 130 can be movable along the outer side 112. For example, a track or other guide can be provided for facilitating movement of the camera 130 therein.

The head-mountable device 100 can include displays 140 that provide visual output for viewing by a user wearing the head-mountable device 100. One or more displays 140 can be positioned on or near an inner side 114 of the frame 110. As used herein, an inner side 114 of a portion of a head-mountable device is a side that faces toward the user and/or away from the external environment.

A display 140 can transmit light from a physical environment (e.g., as captured by a camera) for viewing by the user. Such a display 140 can include optical properties, such as lenses for vision correction based on incoming light from the physical environment. Additionally or alternatively, a display 140 can provide information as a display within a field of view of the user. Such information can be provided to the exclusion of a view of a physical environment or in addition to (e.g., overlaid with) a physical environment.

A physical environment refers to a physical world that people can interact with and/or sense without necessarily requiring the aid of an electronic device. A computer-generated reality environment relates to a partially or wholly simulated environment that people sense and/or interact with the assistance of an electronic device. Examples of computer-generated reality include, but are not limited to, mixed reality and virtual reality. Examples of mixed realities can include augmented reality and augmented virtuality. Examples of electronic devices that enable a person to sense and/or interact with various computer-generated reality environments include head-mountable devices, projection-based devices, heads-up displays (HUDs), vehicle windshields having integrated display capability, windows having integrated display capability, displays formed as lenses designed to be placed on a person's eyes (e.g., similar to contact lenses), headphones/earphones, speaker arrays, input devices (e.g., wearable or handheld controllers with or without haptic feedback), smartphones, tablets, and desktop/laptop computers. A head-mountable device can have an integrated opaque display, have a transparent or translucent display, or be configured to accept an external opaque display from another device (e.g., smartphone).

While the frame 110 is shown schematically with a particular size and shape, it will be understood that the size and shape of the frame 110, particularly at the inner side 114, can have a size and shape that accommodates the face of a user wearing the head-mountable device 100. For example, the inner side 114 can provide a shape that generally matches the contours of the user's face around the eyes of the user. The inner side 114 can be provided with one or more features that allow the frame 110 to conform to the face of the user to enhance comfort and block light from entering the frame 110 at the points of contact with the face. For example, the inner side 114 can provide a flexible, soft, elastic, and/or compliant structure. While the head-mountable device 100 is worn by a user, with the inner side 114 of the frame 110 against the face of the user and/or with the head engager 120 against the head of the user, the frame 110 can remain in a fixed location and orientation with respect to the face and head of the user.

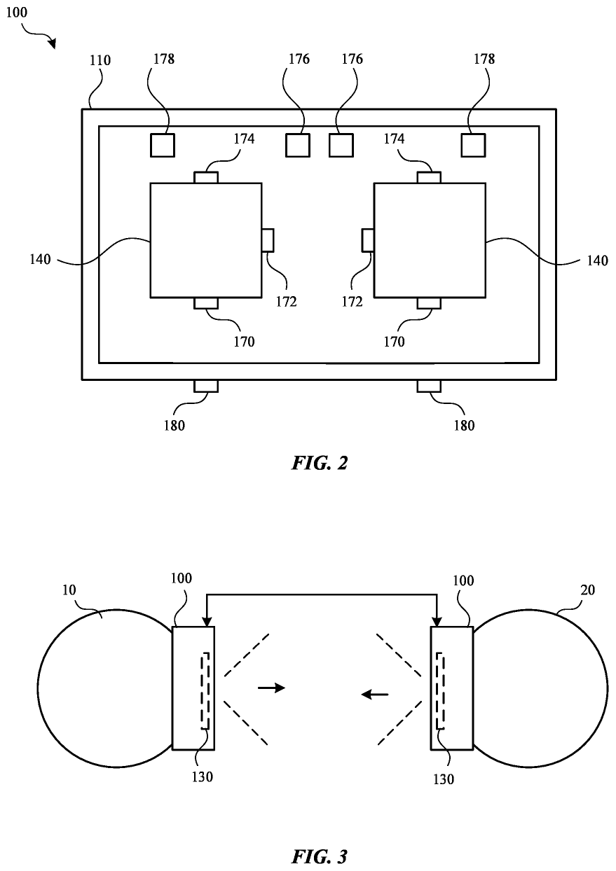

Referring now to FIG. 2, sensors of a head-mountable device can be used to detect facial features of a person wearing the head-mountable device. Such detections can be used to determine how an avatar representing the person should be generated for output to other users. These and/or other detections can also be used to determine reactions by the users observing the avatar, so that adjustment can be made to enhance the user's experience.

As shown in FIG. 2, the head-mountable device 100 can include one or more eye sensors 170 each configured to detect an eye of a user wearing the head-mountable device 100. For example, the eye sensors 170 can capture and/or process an image of an eye and perform analysis based on one or more of hue space, brightness, color space, luminosity, and the like. Such detections can be used to determine the appearance and/or location of an eye as well as a location of a pupil of the eye, which can be used to determine a direction of the user's gaze. Such information (e.g., eye color, eye gaze direction, etc.) can be used (e.g., by another head-mountable device) to generate an avatar having the detected eye features.

The head-mountable device 100 can further include one or more capacitive sensors 172 configured to detect a nose of the user. The capacitive sensors 172 can detect contact, proximity, and/or distance to the nose of the user. Such information (e.g., nose shape, etc.) can be used (e.g., by another head-mountable device) to generate an avatar having the detected nose features.

The head-mountable device 100 can further include one or more temperature sensors 174 configured to detect a temperature of the face of the user. For example, the temperature sensors 174 can include infrared sensors, thermometers, thermocouples, and the like. The temperature information can indicate whether a user is satisfied or unsatisfied with an avatar being displayed. For example, a user's discomfort can increase blood flow and raise the temperature in the facial region. Such information can be used as user feedback and applied adjust an avatar to be more cartoonlike or more lifelike, as described further herein.

The head-mountable device 100 can further include one or more brow cameras 176 configured to detect a brow of the user. For example, the brow cameras 176 can capture and/or process an image of an eyebrow and perform analysis based on one or more of hue space, brightness, color space, luminosity, and the like. Such detections can be used to determine the appearance and/or location of an eyebrow. Such information (e.g., eyebrow color, eyebrow location, etc.) can be used (e.g., by another head-mountable device) to generate an avatar having the detected eyebrow features. Additionally or alternatively, such information can be used as user feedback and applied to adjust an avatar to be more cartoonlike or more lifelike, as described further herein.

The head-mountable device 100 can further include one or more depth sensors 178 configured to detect a shape of a face of the user. For example, the depth sensors 178 can be configured to measure a distance (e.g., range) to a facial feature (e.g., any one or more regions of the user's face) via stereo triangulation, structured light, time-of-flight, interferometry, and the like. Such information can be used (e.g., by another head-mountable device) to generate an avatar having the detected facial features. Additionally or alternatively, such information can be used as user feedback and applied to adjust an avatar to be more cartoonlike or more lifelike, as described further herein.

While some of the sensors in FIG. 2 are illustrated as being at an interior of the head-mountable device 100, other sensors, such as peripheral sensors 180 can be provided at an exterior of the head-mountable device 100. The peripheral sensors 180 can include any one or more of the types of sensors described herein. By being positioned on an exterior of the head-mountable device 100, the peripheral sensors 180 detect other facial features of the user, as well as an environment and/or another user. For example, the peripheral sensors 180 can detect any one of the features described herein with respect to the user's mouth, cheeks, jaw, chin, ears, temples, forehead, and the like. Such information can be used (e.g., by another head-mountable device) to generate an avatar having the detected features. Additionally or alternatively, such information can be used as user feedback and applied to adjust an avatar to be more cartoonlike or more lifelike, as described further herein.

By further example, any number of other sensors can be provided to perform facial feature detection, facial movement detection, facial recognition, eye tracking, user mood detection, user emotion detection, user gestures, voice detection, and the like. The sensors can include force sensors, contact sensors, capacitive sensors, strain gauges, resistive touch sensors, piezoelectric sensors, cameras, pressure sensors, photodiodes, and/or other sensors. By further example, the user sensors can include bio-sensors for tracking biometric characteristics, such as health and activity metrics. The user sensor can include a bio-sensor that is configured to measure biometrics such as electrocardiographic (ECG) characteristics, galvanic skin resistance, and other electrical properties of the user's body. Additionally or alternatively, a bio-sensor can be configured to measure body temperature, exposure to UV radiation, and other health-related information. A user's level of satisfaction with a displayed avatar can be determined based on such detections, and such information can be used as user feedback and applied adjust an avatar to be more cartoonlike or more lifelike, as described further herein.

Additionally or alternatively, the head-mountable device 100 can include sensors that do not relate to the user. For example, such sensors can detect conditions of the head-mountable device 100. For example, the head-mountable device 100 can include an initial measurement unit (“IMU”) that provides information regarding a characteristic of the head-mounted device 100, such as inertial angles thereof. For example, the IMU can include a six-degrees of freedom IMU that calculates the head-mounted device's position, velocity, and/or acceleration based on six degrees of freedom (x, y, z, θₓ, θ_{y}, and 74 _{z}). The IMU can include one or more of an accelerometer, a gyroscope, and/or a magnetometer.

Additionally or alternatively, the head-mounted device can detect motion characteristics of the head-mounted device with one or more other motion sensors, such as an accelerometer, a gyroscope, a global positioning sensor, a tilt sensor, and so on for detecting movement and acceleration of the head-mounted device. Other sensors directed to the head-mountable device 100 itself include temperature sensors, and the like.

The sensors can be operated for operations of the head-mountable device that are not necessarily related to avatar generation, such as alignment of the displays 140. For example, each display 140 can be adjusted to align with a corresponding eye of the user. By further example, each display 140 can be moved along one or more axes until a center of each display 140 is aligned with a center of the corresponding eye. Accordingly, the distance between the displays 140 can be set based on an interpupillary distance of the user. IPD is defined as the distance between the centers of the pupils of a user's eyes.

The pair of displays 140 can be mounted to the frame 110 and separated by a distance. The distance between the pair of displays 140 can be designed to correspond to the IPD of a user. The distance can be adjustable to account for different IPDs of different users that may wear the head-mountable device 100. For example, either or both of the displays 140 may be movably mounted to the frame 110 to permit the displays 140 to move or translate laterally to make the distance larger or smaller. Any type of manual or automatic mechanism may be used to permit the distance between the displays 140 to be an adjustable distance. For example, the displays 140 can be mounted to the frame 110 via slidable tracks or guides that permit manual or electronically actuated movement of one or more of the displays 140 to adjust the distance there between.

Additionally or alternatively, the displays 140 can be moved to a target location based on a desired visual effect that corresponds to user's perception of the display 140 when it is positioned at the target location. The target location can be determined based on a focal length of the user and/or optical elements of the system. For example, the user's eye and/or optical elements of the system can determine how the visual output of the display 140 will be perceived by the user. The distance between the display 140 and the user's eye and/or the distance between the display 140 and one or more optical elements can be altered to place the display 140 at, within, or outside of a corresponding focal distance. Such adjustments can be useful to accommodate a particular user's eye, corrective lenses, and/or a desired optical effect.

Referring now to FIG. 3, head-mountable devices can be worn and operated by different individuals, who can then participate in a shared environment. Within that environment, each user can observe an avatar representing the other individuals dissipating in the shared environment.

As shown in FIG. 3, users 10 and 20 can each be wearing a head-mountable device 100 that provides a view to an environment. In some embodiments, the users 10 and 20 can be in the same physical environment. In other embodiments, the users 10 and 20 can be an different physical environments but still be provided with displayed avatar as of each other to facilitate interactions. It will be understood that the description of the subject technology can apply to users and head-mountable devices that are in the same or different physical environments.

As further shown in FIG. 3, each of the users 10 and 20 can face in a direction that corresponds to the other. Where the users 10 and 20 are sharing the same physical environment, cameras 130 of each head-mountable device 100 can capture a view of the other user and/or the other head-mountable device 100. While the head-mountable devices 100 provide a visual output to each of the users 10 and 20, each user can observe the other in the form of an avatar. To generate such an avatar, a head-mountable device 100 worn by a particular person can detect facial features thereof. Such detections can be transmitted to the other head-mountable device. It will be understood that the transmitted detection's can be any information that is usable to generate an avatar, including raw data regarding the detections and/or process data that includes instructions on how to generate an avatar. The head-mountable device 100 receiving the detections can output and avatar based on the received information. The output of the avatar itself can further be influenced by detections made by the receiving head-mountable device, as described further herein. For example, the receiving head-mountable device that outputs the avatar to its user can further consider feedback received from the user and/or other factors to correspondingly adjust the avatar, if appropriate.

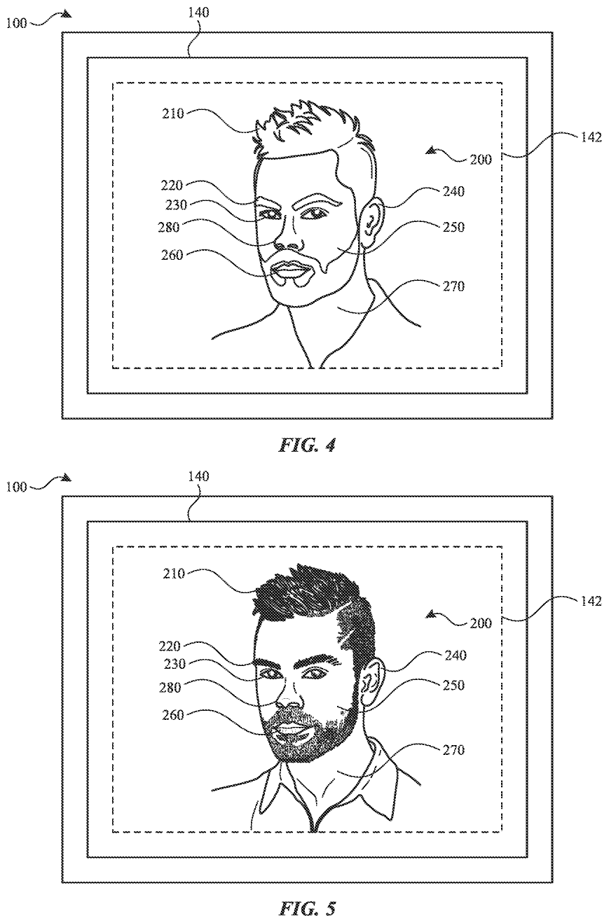

Referring now to FIGS. 4 and 5, a head-mountable device can output and avatar with one of various levels of detail to produce a more cartoonlike avatar or a more lifelike avatar. FIGS. 4 and 5 illustrate rear views of a head-mountable device operable by a user, the head-mountable device providing a user interface 142, according to some embodiments of the present disclosure. The display 140 can provide the user interface 142. Not all of the depicted graphical elements may be used in all implementations, however, and one or more implementations may include additional or different graphical elements than those shown in the figure. Variations in the arrangement and type of the graphical elements may be made without departing from the spirit or scope of the claims as set forth herein. Additional components, different components, or fewer components may be provided.

The interface 142 provided by the display 140 can include an avatar 200 that represents a person wearing a no other head-mountable device. It will be understood that the avatar 200 need not include a representation of the head-mountable device worn by the person. Thus, despite wearing head-mountable devices, each user can observe an avatar that includes facial features that would otherwise be covered by the head-mountable device.

The avatar 200 can be a virtual yet realistic representation of a person based on detections made by the head-mountable device worn by that person. Such detections can be made with respect to features of the person, such as the person's hair 210, eyebrows 220, eyes 230, ears 240, cheeks 250, mouth 260, neck 270, and/or nose 280. One or more of the features of the avatar 200 can be based on detections performed by the head-mountable device worn thereby. Additionally or alternatively, one or more of the features of the avatar 200 can be based on selections made by the person. For example, previous to or concurrent with output of the avatar 200, the person represented by the avatar 200 can select and/or modify one or more of the features. For example, the person can select a hair color that does not correspond to their actual hair color. Some features can be static, such as hair color, eye color, ear shape, and the like. One or more features can be dynamic, such as eye gaze direction, eyebrow location, mouth shape, and the like.

In some embodiments, detected information regarding facial features (e.g., dynamic features) can be mapped to static features in real-time to generate and display the avatar 200. In some cases, the term real-time is used to indicate that the results of the extraction, mapping, rendering, and presentation are performed in response to each motion of the person and can be presented substantially immediately. The observer may feel as if they are looking at the person when looking at the avatar 200.

As shown in FIG. 4, the avatar 200 can be generated to be more cartoonlike. For example, the avatar 200 can be generated with a lower level of detail while still representing features of the person, including real-time poses and motion of the person. By further example, a lower level of detail can include a lower resolution of rendering, a lower number of colors used to perform rendering, a higher level of contrast (e.g., contrast separation), a higher level of smoothing, a different or smaller number of lighting effects, and/or a reduction or omission of a shading effect. Features of the person (e.g., hair 210) can be represented in the avatar 200 with fewer details and more uniformity throughout (e.g., showing only a boundary filled with a single color).

As shown in FIG. 5, the avatar 200 can be generated to be more lifelike. For example, the avatar 200 can be generated with a higher level of detail to more precisely represent features of the person, including real-time poses and motion of the person. By further example, a lower level of detail can include a higher resolution of rendering, a higher number of colors used to perform rendering, a lower level of contrast (e.g., contrast separation), a lower level of smoothing, a different or greater number of lighting effects, and/or an increase or introduction of a shading effect. Features of the person (e.g., hair 210) can be represented in the avatar 200 with a greater number details and more variation throughout (e.g., showing individual hairs).

It will be understood that the head-mountable device 100 can adjust the avatar 200 based on detections, feedback, and/or other information, as described further herein. For example, head-mountable device 100 can switch between the cartoonlike avatar 200 of FIG. 4 and the lifelike avatar 200 of FIG. 5. It will be further understood that a user may find acceptable both cartoonlike and lifelike avatars. In particular, users may find acceptable avatars that are easily recognized to be either cartoonlike or lifelike. However, some users may find less acceptable avatars that are between cartoonlike and lifelike (e.g., having only a medium level of detail). As such, the head-mountable device 100 can consider a variety of factors to determine whether to output an avatar that is cartoonlike or lifelike.

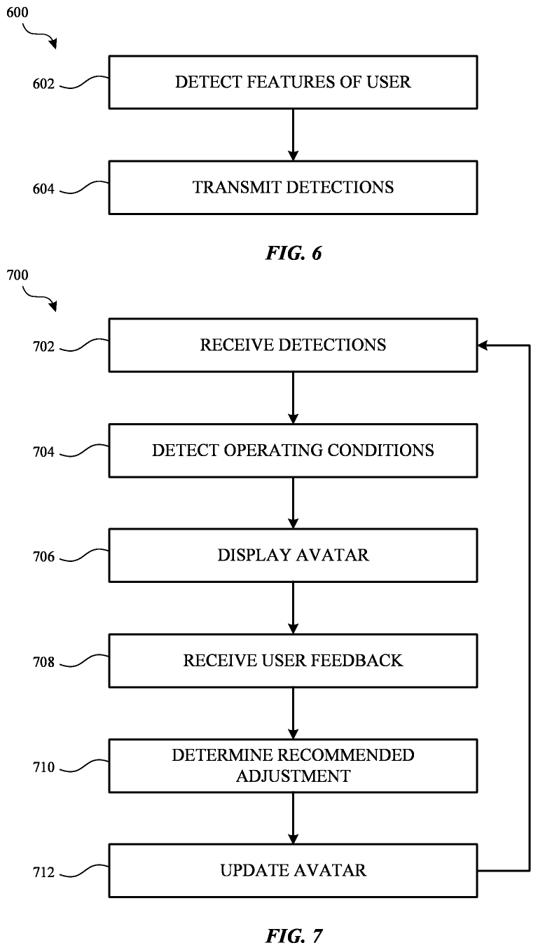

FIG. 6 illustrates a flow diagram of an example process 600 for managing detections with respect to a person wearing a head-mountable device. For explanatory purposes, the process 600 is primarily described herein with reference to the head-mountable devices 100 of FIGS. 1-5. However, the process 600 is not limited to the head-mountable devices 100 of FIGS. 1-5, and one or more blocks (or operations) of the process 600 may be performed by different components of the head-mountable device and/or one or more other devices. Further for explanatory purposes, the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

The process 600 can begin when a head-mountable device detects a face and/or facial feature of a person wearing the head-mountable device (602). Such a detection can be made by one or more sensors of the head-mountable device, as described herein.

The head-mountable device can transmit the detections to another head-mountable device being worn by a user other than the person being detected (604). The detections performed with respect to a person can be the basis for an avatar, and the avatar can be displayed by the other head-mountable device for observation by the user thereof. Such further operations can be performed according to the embodiment illustrated in FIG. 7.

FIG. 7 illustrates another flow diagram of an example process 700 for managing output of an avatar. For explanatory purposes, the process 700 is primarily described herein with reference to the head-mountable devices 100 of FIGS. 1-5. However, the process 700 is not limited to the head-mountable devices 100 of FIGS. 1-5, and one or more blocks (or operations) of the process 700 may be performed by different components of the head-mountable device and/or one or more other devices. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

The process 700 can begin when the head-mountable device receives one or more detections with respect to a person wearing a different head-mountable device (702). For example, the detections can be those that are transmitted in operation 604 of process 600, as described herein.

The head-mountable device receiving the detections can perform one or more operations prior to displaying the avatar. For example, the head-mountable device can optionally detect one or more operating conditions of the head-mountable device (704). The head-mountable device can determine whether one or more operating conditions thereof should govern the manner in which the avatar is output. For example, the head-mountable device can determine a processing ability thereof. Where the head-mountable device has limited processing ability (e.g., where applications thereof are occupying processing power above a threshold), the head-mountable device may determine that a particular type of avatar is most appropriate for display. In some embodiments, a cartoonlike avatar can require less processing power, therefore being more appropriate for a head-mountable device in such situations. In some embodiments, where a head-mountable device has ample processing ability (e.g., where occupied processing power does not exceed a threshold), the head-mountable device can output a more cartoonlike avatar. By further example, the processing ability can be influenced by the temperature of the head-mountable device. Where the temperature exceeds a threshold, it can be preferred to generate a more cartoonlike avatar to reduce processing power and further heat generation. Where the temperature is below threshold, it can be preferred to generate a more lifelike avatar.

In some embodiments, the selection of avatar type can be based on whether the person represented by the avatar is actively speaking. For example, either of the head-mountable devices can determine whether the person represented by the avatar is speaking, for example with a microphone and/or camera of such devices. When the person is speaking, a more lifelike avatar can be generated. When the person is not speaking, a more cartoonlike avatar can be generated. This can help processing power be conserved for when it is most likely that the user will be paying attention to the avatar and the person it represents.

In some embodiments, the selection of avatar type can be based on whether the user wearing the head-mountable device is looking at the avatar. For example, the eye censor of the head-mountable device can determine the eye gaze direction of the user, thereby determining whether or not the user is looking at a known location of the avatar. When the user is looking at the avatar, a more lifelike avatar can be generated. When the user is not looking at the avatar, a more cartoonlike avatar can be generated. This can help processing power be conserved for when it is most likely that the user will be paying attention to the avatar and the person it represents.

It will be understood that the selection of avatar and/or features thereof can be further adjusted by other considerations, as described further herein.

The head-mountable device can output the avatar by operating the display thereof (706). For example, the display can provide an interface that includes the avatar when the user is facing a direction corresponding to the designated location representing the person.

The head-mountable device can receive user feedback while the avatar is being displayed (708). For example, the head-mountable device can operate one or more sensors thereof, as described herein, to determine a user's level of satisfaction or dissatisfaction with the avatar being displayed. Detections can be correlated with a user satisfaction or dissatisfaction with the displayed avatar, and the head-mountable device can determine whether or not the displayed avatar is acceptable to the user. Additionally or alternatively, the head-mountable device can receive user input from the user, including operation of an input device (e.g., keyboard, mouse, crown, button, touchpad, and the like), voice, gestures, and the like.

The head-mountable device can determine whether an adjustment to the avatar is recommended (710) for example, the head-mountable device can, upon detection that the user satisfaction is below a threshold, determine that the avatar should be either more cartoonlike or lifelike. In some embodiments, an adjustment in either direction can increase the satisfaction of the user. In some embodiments, the decision whether to adjust the avatar to be more cartoonlike or lifelike can be based on other operating conditions of the head-mountable device, as described herein. In some embodiments, the decision whether to adjust the avatar to be more cartoonlike or lifelike can be based on a user input. For example, the head-mountable device, upon detection that the user satisfaction is below threshold, can prompt the user with options to adjust the avatar to be either more cartoonlike or lifelike.

The head-mountable device can update the avatar based the recommended adjustment (712). For example, the head-mountable device can determine a level of cartoonlike or lifelike features to be applied to the avatar. It will be understood that such a determination can be made prior to application to the actual avatar to be displayed. In particular, the selection of cartoonlike or lifelike features can be made and subsequently applied to further detections made with respect to the person. As such, the avatar can be updated based on subsequent detections that are received from the other head-mountable device.

It will be understood that multiple items of feedback can collectively determine one or more features of an avatar. For example, over time feedback can be collected and stored to tune the avatar to a user's preferences. Such feedback can be stored in memory of the head-mountable device, and the head-mountable device to correlate user feedback with the characteristic (e.g., style, level of detail, etc.) of an avatar being output while the feedback was received from the user. In future operations, the head-mountable device can receive additional feedback from the user while an updated avatar is being output on the display. Adjustments to be determined as recommended can be based on both historical feedback and present (e.g., additional) feedback from the user. An avatar can be updated accordingly. Thus, over time, the head-mountable device can tune its avatar output to the inferred preferences of the user.

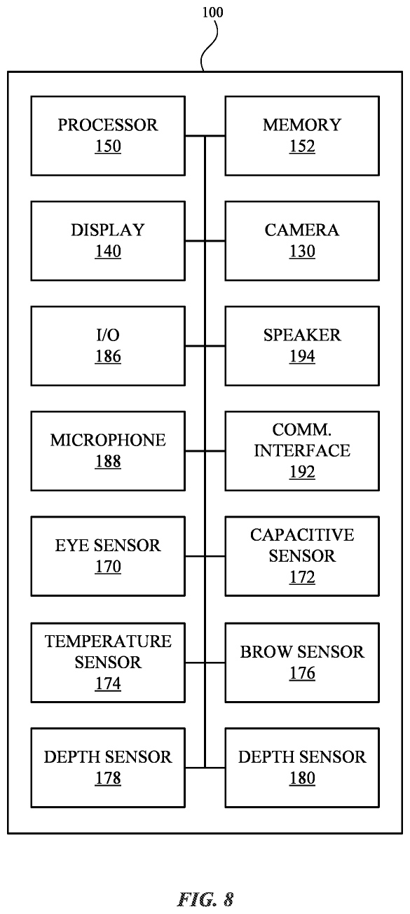

Referring now to FIG. 8, components of the head-mountable device can be operably connected to provide the performance described herein. FIG. 8 shows a simplified block diagram of an illustrative head-mountable device 100 in accordance with one embodiment of the invention. It will be appreciated that components described herein can be provided on one, some, or all of a frame and/or a head engager. It will be understood that additional components, different components, or fewer components than those illustrated may be utilized within the scope of the subject disclosure.

As shown in FIG. 8, the head-mountable device 100 can include a processor 150 (e.g., control circuitry) with one or more processing units that include or are configured to access a memory 152 having instructions stored thereon. The instructions or computer programs may be configured to perform one or more of the operations or functions described with respect to the head-mountable device 100. The processor 150 can be implemented as any electronic device capable of processing, receiving, or transmitting data or instructions. For example, the processor 150 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 152 can store electronic data that can be used by the head-mountable device 100. For example, the memory 152 can store electrical data or content such as, for example, audio and video files, documents and applications, device settings and user preferences, timing and control signals or data for the various modules, data structures or databases, and so on. The memory 152 can be configured as any type of memory. By way of example only, the memory 152 can be implemented as random access memory, read-only memory, Flash memory, removable memory, or other types of storage elements, or combinations of such devices.

The head-mountable device 100 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDs, LEDS, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. The head-mountable device 100 can include an optical subassembly configured to help optically adjust and correctly project the image-based content being displayed by the display 140 for close up viewing. The optical subassembly can include one or more lenses, mirrors, or other optical devices.

The head-mountable device 100 can further include a camera 130 for capturing a view of an external environment, as described herein. The view captured by the camera can be presented by the display 140 or otherwise analyzed to provide a basis for an output on the display 140. The camera 130 can further be operated to capture a view of another head-mountable device and/or a person wearing the other head-mountable device, as described herein.

The head-mountable device 100 can include an input/output component 186, which can include any suitable component for connecting head-mountable device 100 to other devices. Suitable components can include, for example, audio/video jacks, data connectors, or any additional or alternative input/output components. The input/output component 186 can include buttons, keys, or another feature that can act as a keyboard for operation by the user. The input/output component 186 can include a haptic device that provides haptic feedback with tactile sensations to the user.

The head-mountable device 100 can include the microphone 188 as described herein. The microphone 188 can be operably connected to the processor 150 for detection of sound levels and communication of detections for further processing, as described further herein.

The head-mountable device 100 can include the speakers 194 as described herein. The speakers 194 can be operably connected to the processor 150 for control of speaker output, including sound levels, as described further herein.

The head-mountable device 100 can include communications interface 192 for communicating with one or more servers or other devices using any suitable communications protocol. For example, communications interface 192 can support Wi-Fi (e.g., a 802.11 protocol), Ethernet, Bluetooth, high frequency systems (e.g., 900 MHz, 2.4 GHZ, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications interface 192 can also include an antenna for transmitting and receiving electromagnetic signals. For example, the communications interface 192 of one head-mountable device 100 can communicate with the communications interface of another head-mountable device. Such communications can relate to detection of a person wearing a head-mountable device, which are transmitted to the other head-mountable device for generation of an avatar, as described herein.

The head-mountable device 100 can include one or more eye sensors 170 each configured to detect an eye of a user wearing the head-mountable device 100. The head-mountable device 100 can further include one or more capacitive sensors 172 configured to detect a nose of the user. The head-mountable device 100 can further include one or more temperature sensors 174 configured to detect a temperature of the face of the user. The head-mountable device 100 can further include one or more brow cameras 176 configured to detect a brow of the user. The head-mountable device 100 can further include one or more depth sensors 178 configured to detect a shape of a face of the user. The head-mountable device 100 can include one or more peripheral sensors 180 to detect other facial features of the user, as well as an environment and/or another user.

The head-mountable device 100 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include the camera 130 which can capture image-based content of the outside world.

The head-mountable device 100 can include a battery, which can charge and/or power components of the head-mountable device 100. The battery can also charge and/or power components connected to the head-mountable device 100.

Accordingly, embodiments of the present disclosure provide a head-mountable device with user-facing sensors to track facial features of a person wearing the head-mountable device. Detections can be transmitted to other head-mountable devices so that avatars of the person can be displayed thereon. The users observing such avatars can respond to the selected level of realism, and the head-mountable devices worn by such users can detect or otherwise receive feedback from the users, for example with sensors to track facial features. Such reactions can be used to determine whether the avatar should be adjusted, for example to be more cartoonlike or lifelike. Additionally, reactions over time can be tracked to determine a user's overall responsiveness to cartoonlike or lifelike avatars, and futures avatars can be generated based on such determinations.

Various examples of aspects of the disclosure are described below as clauses for convenience. These are provided as examples, and do not limit the subject technology.

Clause A: a head-mountable device comprising: a communication interface configured to receive, from an additional head-mountable device, a detection of a person wearing the additional head-mountable device; a display operable to output an avatar based on the detection of the person; and a processor configured to: receive feedback from a user wearing the head-mountable device while the avatar is being output on the display; based on the feedback, determine a recommended adjustment to the avatar; and operate the display to output an updated avatar based on the recommended adjustment.

Clause B: a head-mountable device comprising: a communication interface configured to receive, from an additional head-mountable device, a detection of a person wearing the additional head-mountable device; a display; and a processor configured to: determine a processing ability of the head-mountable device; and operate the display to output an avatar having a characteristic based on the detection of the person and the processing ability.

Clause C: a head-mountable device comprising: an eye sensor configured to detect an eye of a user wearing the head-mountable device; a capacitive sensor configured to detect a nose of the user; a brow camera configured to detect a brow of the user; a depth sensor configured to detect a shape of a face of the user; and a communication interface configured to transmit, to an additional head-mountable device, the detections of the eye of the user, the nose of the user, the brow of the user, and the face of the user.

One or more of the above clauses can include one or more of the features described below. It is noted that any of the following clauses may be combined in any combination with each other, and placed into a respective independent clause, e.g., clause A, B, or C.

Clause 1: a sensor for detecting a facial feature of the user, wherein the feedback is the detected facial feature.

Clause 2: the sensor is a temperature sensor.

Clause 3: a camera for detecting the person or the additional head-mountable device, wherein the output of the avatar is further based on a detection by the camera.

Clause 4: a memory, wherein the processor is further configured to store the feedback from the user and a characteristic of the avatar being output while the feedback was received from the user.

Clause 5: the processor is further configured to: receive additional feedback from the user while the updated avatar is being output on the display; based on the stored feedback and the additional feedback, determine an additional adjustment to the avatar; and operate the display to output an additional updated avatar based on the additional recommended adjustment.

Clause 6: the recommended adjustment is a change to a characteristic applied to render the avatar, the characteristic comprising a level of detail, a number of colors, a contrast, a lighting effect, or a shading effect.

Clause 7: the processor is further configured to determine a processing ability of the head-mountable device, wherein the avatar is output with a characteristic based on the processing ability of the head-mountable device.

Clause 8: the processor is further configured to determine whether the person is speaking, wherein the recommended adjustment is determined based on whether the person is speaking.

Clause 9: a sensor configured to detect whether a gaze of the user is directed to the avatar, wherein the recommended adjustment is determined based on whether the gaze of the user is directed to the avatar.

Clause 10: the characteristic comprises a level of detail, a number of colors, a contrast, a lighting effect, or a shading effect.

Clause 11: a camera for detecting the person or the additional head-mountable device, wherein the output of the avatar is further based on a detection by the camera.

Clause 12: the processor is further configured to: receive feedback from a user wearing the head-mountable device while the avatar is being output on the display; based on the feedback, determine a recommended adjustment to the avatar; and operate the display to output an updated avatar based on the recommended adjustment.

Clause 13: a display, wherein the eye sensor is mounted to the display, the display and the eye sensor being moveable within the head-mountable device.

Clause 14: the communication interface is further configured to receive, from the additional head-mountable device, a detection of a person wearing the additional head-mountable device; and the display is operable to output an avatar based on the detection of the person.

Clause 15: a processor configured to: receive feedback from a user wearing the head-mountable device while the avatar is being output on the display; based on the feedback, determine a recommended adjustment to the avatar; and operate the display to output an updated avatar based on the recommended adjustment.

Clause 16: a temperature sensor configured to detect a temperature of the face of the user.

As described herein, aspects of the present technology can include the gathering and use of data. The present disclosure contemplates that in some instances, gathered data can include personal information or other data that uniquely identifies or can be used to locate or contact a specific person. The present disclosure contemplates that the entities responsible for the collection, analysis, disclosure, transfer, storage, or other use of such personal information or other data will comply with well-established privacy practices and/or privacy policies. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a communication interface configured to receive, from an additional head-mountable device, a detection of a person wearing the additional head-mountable device;
a display operable to output an avatar based on the detection of the person; and
a processor configured to:
receive feedback while the avatar is being output on the display;
based on the feedback, determine a recommended adjustment to the avatar; and
operate the display to output an updated avatar based on the recommended adjustment.

2. The head-mountable device of claim 1, further comprising a sensor for detecting a facial feature, wherein the feedback is the detected facial feature.

3. The head-mountable device of claim 2, wherein the sensor is a temperature sensor.

4. The head-mountable device of claim 1, further comprising a camera for detecting the person or the additional head-mountable device, wherein the output of the avatar is further based on a detection by the camera.

5. The head-mountable device of claim 1, further comprising a memory, wherein the processor is further configured to store the feedback and a characteristic of the avatar being output while the feedback was received.

6. The head-mountable device of claim 5, wherein the processor is further configured to:
receive additional feedback while the updated avatar is being output on the display;
based on the stored feedback and the additional feedback, determine additional adjustment to the avatar; and
operate the display to output an additional updated avatar based on the additional adjustment.

7. The head-mountable device of claim 5, wherein the recommended adjustment is a change to a characteristic applied to render the avatar, the characteristic comprising a level of detail, a number of colors, a contrast, a lighting effect, or a shading effect.

8. The head-mountable device of claim 5, wherein the processor is further configured to determine a processing ability of the head-mountable device, wherein the avatar is output with a characteristic based on the processing ability of the head-mountable device.

9. The head-mountable device of claim 5, wherein the processor is further configured to determine whether the person is speaking, wherein the recommended adjustment is determined based on whether the person is speaking.

10. The head-mountable device of claim 5, further comprising a sensor configured to detect whether a gaze of an eye is directed to the avatar, wherein the recommended adjustment is determined based on whether the gaze is directed to the avatar.

11. A head-mountable device comprising:
a communication interface configured to receive, from an additional head-mountable device, a detection of a person wearing the additional head-mountable device;
a display; and
a processor configured to:
determine a processing ability of the head-mountable device; and
operate the display to output an avatar having a characteristic based on the detection of the person and the processing ability.

12. The head-mountable device of claim 11, wherein the characteristic comprises a level of detail, a number of colors, a contrast, a lighting effect, or a shading effect.

13. The head-mountable device of claim 11, further comprising a camera for detecting the person or the additional head-mountable device, wherein the output of the avatar is further based on a detection by the camera.

14. The head-mountable device of claim 11, wherein the processor is further configured to:
receive feedback while the avatar is being output on the display;
based on the feedback, determine a recommended adjustment to the avatar; and
operate the display to output an updated avatar based on the recommended adjustment.

15. A head-mountable device comprising:
an eye sensor configured to detect an eye;
a capacitive sensor configured to detect a nose;
a brow camera configured to detect a brow;
a depth sensor configured to detect a shape of a face; and
a communication interface configured to transmit, to an additional head-mountable device, the detections of the eye, the nose, the brow, and the face.

16. The head-mountable device of claim 15, further comprising a display, wherein the eye sensor is mounted to the display, the display and the eye sensor being moveable within the head-mountable device.

17. The head-mountable device of claim 16, wherein:
the communication interface is further configured to receive, from the additional head-mountable device, a detection of a person wearing the additional head-mountable device; and
the display is operable to output an avatar based on the detection of the person.

18. The head-mountable device of claim 17, further comprising a processor configured to:
receive feedback while the avatar is being output on the display;
based on the feedback, determine a recommended adjustment to the avatar; and
operate the display to output an updated avatar based on the recommended adjustment.

19. The head-mountable device of claim 15, further comprising a temperature sensor configured to detect a temperature of the face.

20. The head-mountable device of claim 15, further comprising a peripheral sensor positioned to detect a feature that is outside of the head-mountable device.
